(19) United States
(12) Patent Application Publication
(10) Pub. No.: US 2006/0257123 A1
(43) Pub. Date: Nov. 16, 2006

(54) System and a method for recording a broadcast displayed on a mobile device

(76) Inventors: Tzvetan T. Horozov, Hoffman Estates, IL (US); Jay R. Almaula, Bartlett, IL (US); Bhavan R. Gandhi, Vernon Hills, IL (US); Anwar M. Haneef, Streamwood, IL (US); Venugopal Vasudevan, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 11/128,477

(22) Filed: May 13, 2005

(51) Int. Cl. H04N 7/26

(52) U.S. Cl. 386/112

(57) ABSTRACT

A system and a method for recording a broadcast being displayed on a mobile device. The system includes a mobile device (102), a server (104), and a Digital Video Recorder (DVR) (106). The mobile device receives and displays a broadcast. Further, the mobile device generates a first information pertaining to the broadcast and sends it to the server. The server, on receiving the first information, generates a second information, and then sends the second information to the DVR. The DVR, on receiving the second information from the server records the broadcast.

### FIELD OF THE INVENTION

The present invention relates generally to a mobile device. In particular, the present invention relates to recording a broadcast being displayed on a mobile device.

### BACKGROUND OF THE INVENTION

Recent innovations enable mobile devices to display a broadcast in a format that is compatible with the device. However, due to limited resources (such as storage space, processing power and battery life) on the mobile device, recording the broadcast on the mobile device is difficult. Further, the broadcast received on the mobile device has a low resolution and is of inferior quality, making it unsuitable for recording. As a result, it is better to record the broadcast by using a secondary device such as a Digital Video Recorder (DVR).

DVRs allow a user to record a broadcast being transmitted by a broadcast source. The recorded broadcast may be stored on a storage device such as a Hard Disk Drive (HDD), a Compact Disk (CD) or a Digital Versatile Disk (DVD). The broadcast may be encoded and/or compressed before storing it on the storage device. The recorded broadcast may be displayed on a television (TV) set or other display device. The term display device, as used herein, refers to known display associated with a TV or computer system, including desktop and laptop systems.

There are various systems for recording a broadcast from a broadcasting source, using a recording device. In one such system, a server stores the broadcast when a user sends an instruction to the server through the Internet, using a computer. In another system, a user may access an Electronic Program Guide (EPG) through a network (such as a Local Area Network, Internet or a phone line) or a remote control, to record the broadcast on a Digital Video Recorder (DVR). Once the broadcast is selected for recording, the user may control the recording by using the EPG and the DVR. In yet another system, a user may log on to a program server, to select the broadcast to be recorded on a recording device. The program server has a program selection tool that helps the user to select the program to be recorded. Once a program is selected, the program server begins controlling the recording device to monitor the recording.

One concern with the above-mentioned systems is that they do not provide any mechanism to spontaneously record the broadcast being displayed on the mobile device.

Another concern with the above-mentioned systems is that they do not provide any mechanism to encode the broadcast in a desired format.

Yet another concern with the above-mentioned system is that they do not allow a user to control the recording of the broadcast.

Accordingly, there is a need of a system that allows spontaneous recording of the broadcast being displayed on the mobile device. The system should also provide a mechanism that encodes the broadcast in a desired format, and allows the user to control the recording of the broadcast.

### BRIEF DESCRIPTION OF THE DRAWINGS

The present invention is illustrated by way of example, and not limitation, in the accompanying figures, in which like references indicate similar elements, and in which:

FIG. 1 is block diagram illustrating a network, where various embodiments of the present invention may be practiced.

FIG. 2 is a block diagram illustrating a system for recording a broadcast, in accordance with an exemplary embodiment of the present invention.

FIG. 3 is a block diagram illustrating the components of a Digital Video Recorder (DVR), in accordance with an exemplary embodiment of the present invention.

FIG. 4 illustrates a flow diagram for recording a broadcast by using a mobile device, in accordance with an exemplary embodiment of the present invention.

FIG. 5 illustrates a flow diagram for recording a broadcast by using a mobile device, in accordance with another exemplary embodiment of the present invention.

FIG. 6 illustrates a flow diagram for recording a broadcast using a mobile device, in accordance with an exemplary embodiment of the present invention.

FIG. 7 illustrates a chart depicting various cases for broadcast synchronization over a network, in accordance with an exemplary embodiment of the present invention.

FIG. 8 illustrates a flow diagram for playing back a recorded broadcast, in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

One aspect of the present invention is a system for recording a broadcast. The system includes a mobile device, a server, and a Digital Video Recorder (DVR). The mobile device receives and displays the broadcast transmitted from a first Broadcast Source (BS). The mobile device generates a first information pertaining to the broadcast and sends it to the server. The server also receives a first identity of the first BS and a second identity of a second BS. The second BS provides the broadcast to the DVR. The server generates a second information, based on the first information, the first identity, and the second identity. The second information is then sent to the DVR. The DVR, on receiving the second information, starts recording the broadcast being transmitted from the second BS.

Another aspect of the present invention is a method for playing back a recorded broadcast. The recorded broadcast is decoded in a predefined format, suitable for displaying the recorded broadcast on a mobile device. After decoding the recorded broadcast, the recorded broadcast is streamed to the mobile device. Further, a user of the mobile device user may control the playing back of the recorded broadcast.

Before describing in detail a method and system for recording a broadcast, in accordance with the present invention, it should be observed that the present invention resides primarily in combinations of method steps and apparatus components related to the above system. Accordingly, the apparatus components and method steps have been represented, where appropriate, by conventional symbols in the drawings. These drawings show only the specific details that are pertinent for understanding the present invention, so as not to obscure the disclosure with details that will be apparent to those with ordinary skill in the art, and the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

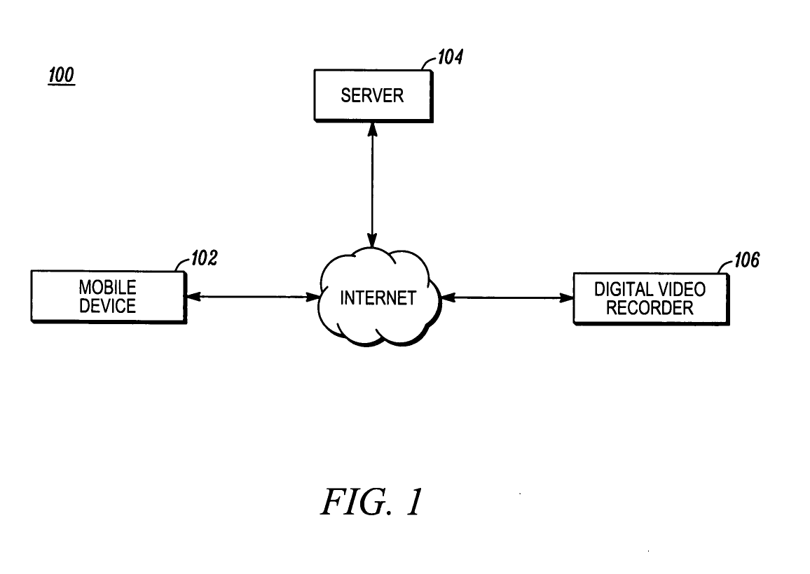

Referring to FIG. 1, there is shown a block diagram of a network 100 where various embodiments of the present invention may be practiced. The network 100 may be a Local Area Network (LAN), a Metropolitan Area Network (MAN), or a Wide Area Network (WAN) such as the Internet. In addition, the network 100 may be a wired or wireless network. The network 100 includes a mobile device 102, a server 104, and a Digital Video Recorder (DVR) 106.

The mobile device 102 is capable of displaying a broadcast. When a user selects a record option on the mobile device 102, for recording the broadcast, the mobile device 102 sends a first information related to the broadcast to the server 104. The mobile device 102 may send the first information through the Internet. The server 104, on receiving the first information, generates a second information. The server 104 then sends the second information to the DVR 106 through the Internet. The DVR 106, on receiving the second information, starts recording the broadcast.

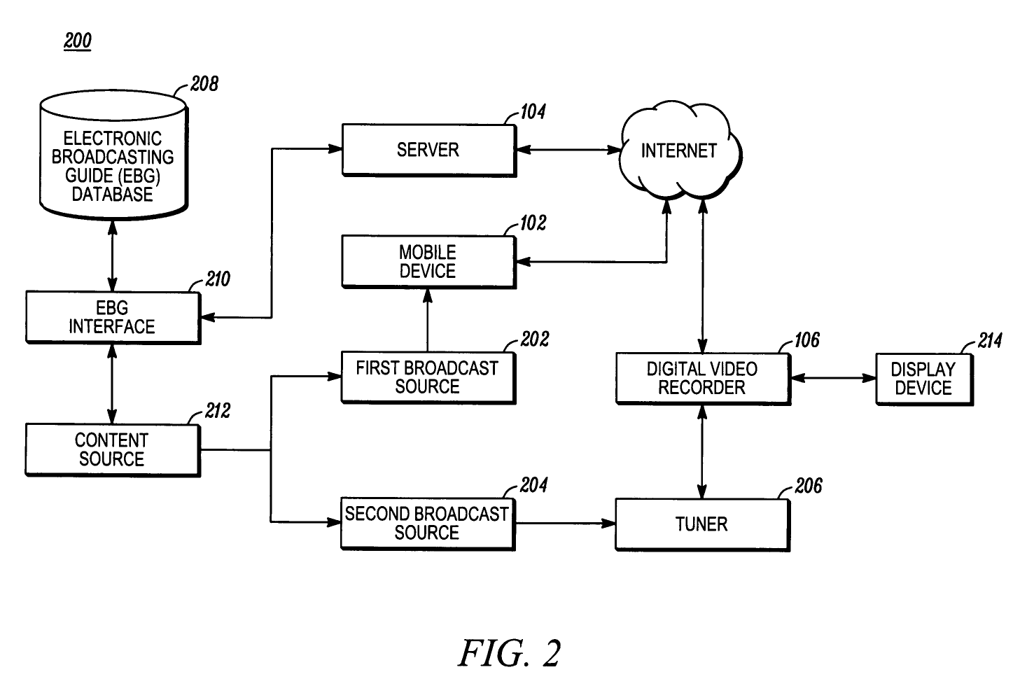

Referring to FIG. 2, there is shown a block diagram of a system 200 for recording a broadcast, in accordance with an exemplary embodiment of the present invention. The system 200 includes the mobile device 102, the server 104, the Digital Video Recorder (DVR) 106, a first Broadcast Source (BS) 202, a second BS 204, a tuner 206, an Electronic Broadcast Guide (EBG) database 208, an EBG interface 210, and a content source 212.

The mobile device 102 is capable of displaying a broadcast being transmitted by the first BS 202. The first BS 202 transmits the broadcast in a format that is compatible with the mobile device 102, in accordance with an embodiment of the invention. For example, the first BS 202 may transmit the broadcast in a DVB-H format that is compatible with the mobile device 102. The second BS 204 transmits the broadcast to the DVR 106 in a format that is compatible with the DVR 106, in accordance with an embodiment of the invention. For example, the second BS 204 may transmit the broadcast in one of a DVB-T format, a DVB-C format, and a DVB-S format that are compatible with the DVR 106. The DVR 106 receives the broadcast with the help of the tuner 206. The DVR 106 records the broadcast based on information received from the server 104, which generates the information based on details of the broadcast being sent by the mobile device 102, a first identity, and a second identity. In one embodiment of the present invention, the server 104 sends the information directly to the DVR 106. In another embodiment of the present invention, the server 104 sends the information to the mobile device 102, which then sends the information to the DVR 106. The first identity includes details pertaining to the broadcast. The second identity includes details pertaining to the second BS 204. The first identity and the second identity are provided to the server 104 by the EBG database 208.

The EBG database 208 stores details related to the broadcasts transmitted by various content sources, for example, the content source 212. The EBG database 208 includes details about the broadcasts. The details may include the time of the broadcasts, the broadcasting sources, and the duration of the broadcasts. For example, for a movie that is being broadcasted, the EBG database 208 may contain details such as the name of the movie, different broadcast sources that are transmitting the movie, the time of the different broadcast sources transmitting the movie, duration of the movie, and cast of the movie. The EBG database 208 provides details pertaining to the broadcast, through the EBG interface 210. The EBG interface 210 allows the server 104 and the content source 212 to access the EBG database 208. The server 104 accesses the EBG database 208 to query for the first identity and the second identity. The content source 212 accesses the EBG database 208, to store details pertaining to the broadcast, the first BS 202, and the second BS 204.

In an exemplary embodiment of the present invention, the content source 212 provides the broadcast to the first BS 202 and the second BS 204, to provide the broadcast to the mobile device 102 and the DVR 106, respectively. In one embodiment of the present invention, the system 200 includes a display device 214, to display a broadcast recorded in the DVR 106.

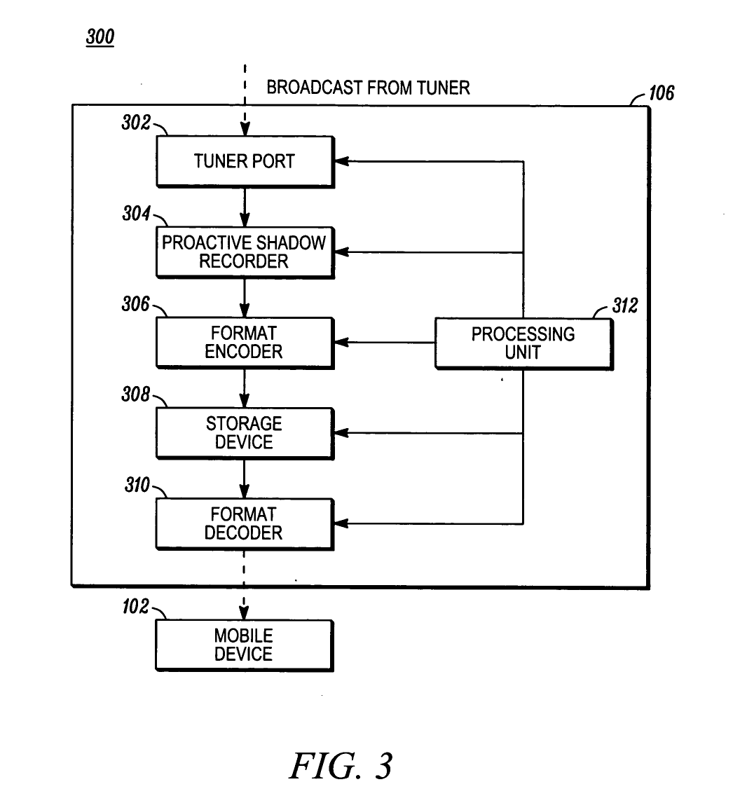

Referring to FIG. 3, there is shown a block diagram 300 of the components of the DVR 106, in accordance with an exemplary embodiment of the present invention. The DVR 106 includes a tuner port 302, a proactive shadow recorder 304, a format encoder 306, a storage device 308, and a format decoder 310.

The tuner port 302 connects the tuner 206 (shown in FIG. 2) to the DVR 106. The DVR 106 receives the broadcast being transmitted from the second BS 204, from the tuner 206, through the tuner port 302. The broadcast is then passed to the proactive shadow recorder 304. The proactive shadow recorder 304, buffers the broadcast. The proactive shadow recorder 304 starts buffering the broadcast as soon as the broadcast transmitted from the first BS 202 is displayed on the mobile device 102. When a user selects a record option on the mobile device 102, to record the broadcast, the broadcast buffered in the proactive shadow recorder 304 is passed to the format encoder 306. The format encoder 306 encodes the broadcast in a predefined format. The broadcast is then passed to the storage device 308 for storing. The storage device 308 stores the broadcast.

The broadcast stored in the storage device 308 is retrieved whenever the user of the mobile device 102 selects a play back option on the mobile device 102. The broadcast, stored in the storage device 308, is then passed to the format decoder 310. The format decoder 310 decodes the broadcast in a format that displays the broadcast on the mobile device 102. The broadcast decoded by the format decoder 310 is sent to the mobile device 102, and may be sent to the mobile device 102 by using wireless means, in accordance with an embodiment of the present invention.

A user may play the recorded broadcast on the display device 214 (shown in FIG. 2) by selecting a play option on a remote control device (not shown in FIG. 3). The remote control device is capable of interacting with the DVR 106. The format decoder 310 then decodes the broadcast (stored in the storage device 308) in a predefined format and displays the broadcast on the display device 214 (not shown in the figure). A processing unit 312 controls and synchronizes the interaction between various components of the DVR 106.

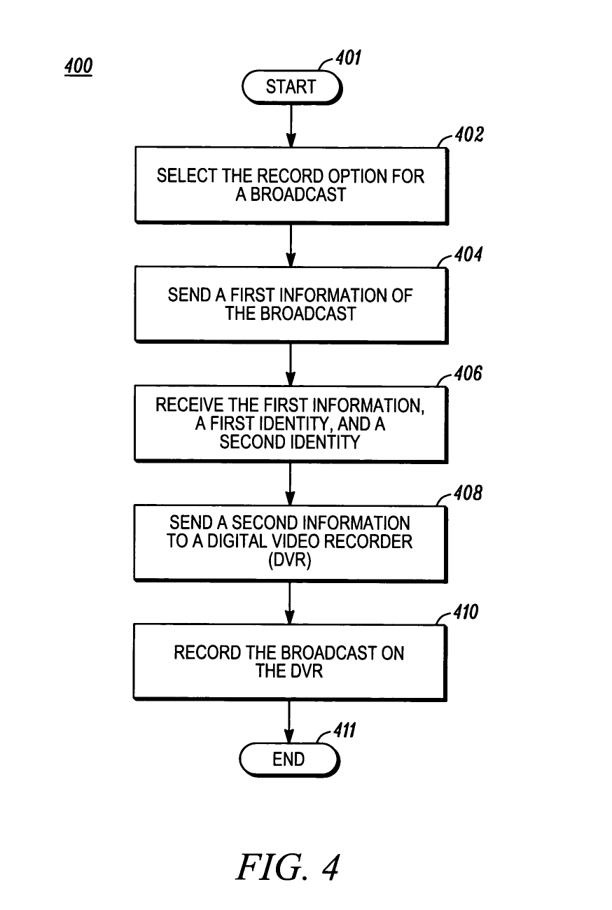

Referring to FIG. 4, there is shown a flow diagram 400 for recording a broadcast by using the mobile device 102, in accordance with an exemplary embodiment of the present invention. After initiating the process at step 401, a user selects a record option on the mobile device 102 to record the broadcast being displayed on the mobile device 102, at step 402. The broadcast being displayed on the mobile device 102 is transmitted from the first BS 202. At step 404, the mobile device 102 sends a first information of the broadcast being transmitted from the first BS 202 to the server 104. In an embodiment of the present invention, the first information is generated, based on metadata associated with the broadcast. Metadata may include details such as name of the broadcast, schedule, duration and genre of the broadcast. In an embodiment of the present invention, the first information may be a unique identity. The unique identity identifies the broadcast globally and may be provided by the content source 212. In another embodiment of the present invention, the first information may be a unique text. The unique text may contain details such as the name of the content source 212; and the time, length and name of the broadcast. The unique text identifies the broadcast globally and may be provided by the content source 212.

At step 406, the server 104 receives the first information from the mobile device 102. The server 104 also receives a first identity of the first BS 202 and a second identity of the second BS 204. At step 408, the server 104 sends a second information to the DVR 106. The second information is generated, based on the first information, the first identity, and a second identity, in accordance with an embodiment of the invention. In an embodiment of the present invention, the second information includes a record instruction for the DVR 106. At step 410, the DVR 106 starts recording the broadcast being transmitted from the second BS 204, based on the second information. Thereafter, the process terminates at step 411.

In one embodiment of the present invention, the server 104 sends the second information directly to the DVR 106. In another embodiment of the present invention, the server 104 sends the second information to the mobile device 102. The mobile device 102 then sends the second information to the DVR 106.

In an embodiment of the present invention, the broadcast may be a content being provided by a service provider over the Internet. The first BS 202 and the second BS 204 may be the same, in accordance with an embodiment of the present invention.

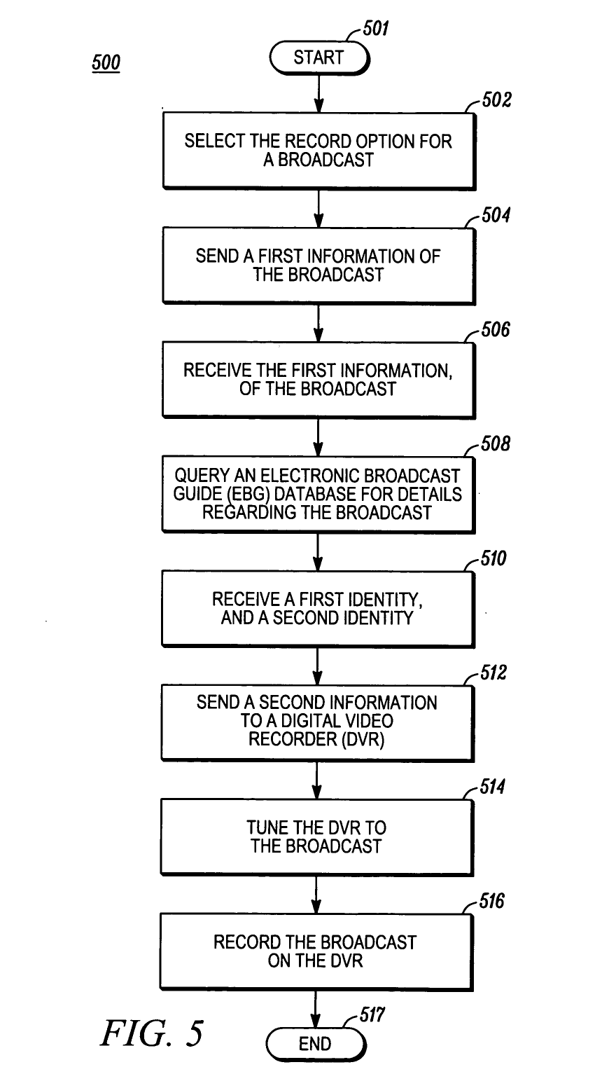

Referring to FIG. 5, there is shown a flow diagram 500 for recording a broadcast by using the mobile device 102, in accordance with another exemplary embodiment of the present invention. After initiating the process at step 501, a user selects a record option on the mobile device 102, to record the broadcast being displayed on the mobile device 102, at step 502. The broadcast being displayed on the mobile device 102 is transmitted from the first BS 202. At step 504, the mobile device 102 sends a first information of the broadcast being transmitted from the first BS 202 to the server 104. In an embodiment of the present invention, the first information is generated, based on metadata associated with the broadcast. At step 506, the server 104 receives the first information from the mobile device 102. At step 508, the server 104 queries the EBG database 208 for details regarding pertaining to the broadcast, based on the first information received by the server 104. At step 510, the server 104 receives the first identity of the first BS 202 and the second identity of the second BS 204. At step 512, the sever 104 sends a second information to the DVR 106. The second information is generated, based on the first information, the first identity, and a second identity, in accordance with an embodiment of the invention. In an embodiment of the present invention, the second information includes a record instruction for the DVR 106. At step 514, the DVR 106 is tuned to the broadcast being transmitted from the second BS 204. At step 516, the DVR 106 starts recording the broadcast being transmitted from the second BS 204, based on the second information received from the server 104. Thereafter, the process terminates at step 517.

In an embodiment of the present invention, a proactive shadow recorder 304 starts buffering the broadcast from the moment a user starts watching the broadcast on the mobile device 102. The user of the mobile device 102 may select the size of the buffer. As the buffering reaches a maximum size, a buffered portion of the broadcast is discarded in a First In First Out (FIFO) order. Further, the buffer always contains the latest interval of the broadcast (that is equal to the size of the buffer). The content of the buffer is added to the storage device 308 as soon as the user of the mobile device 102 selects the record option from the mobile device 102.

To accommodate the above technique, the mobile device 102 may notify the DVR 106 every time the user of the mobile device 102 switches from one broadcast to another. Further, the proactive shadow recorder 304 initializes the buffer for buffering a new broadcast.

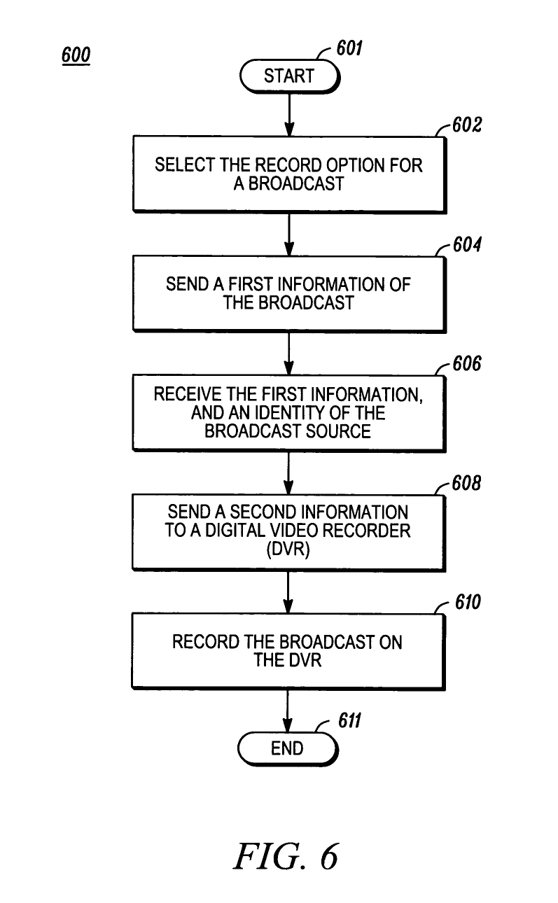

Referring to FIG. 6, there is shown a flow diagram 600 for recording a broadcast using the mobile device 102, in accordance with an exemplary embodiment of the present invention. After initiating the process at step 601, a user selects a record option on the mobile device 102, to record the broadcast being displayed on the mobile device 102, at step 602. In one embodiment of the present invention, the broadcast being displayed on the mobile device 102 may be a cached content. In an embodiment of the present invention, the cached content may be cached from a site on the Internet. In another embodiment of the present invention, the cached content may be cached from the first BS 202. At step 604, the mobile device 102 sends the first information of the broadcast to the server 104. At step 606, the server 104 receives the first information of the broadcast and an identity of the second BS 204. At step 608, the server 104 sends a second information of the DVR 106. The second information is generated on the basis of the first information, and the identity. In an embodiment of the present invention, the second information may include a record instruction for the DVR 106. At step 610, the DVR 106 starts recording the broadcast being transmitted from the second BS 204, based on the information received from the server 104. Thereafter, the process terminates at step 611.

In one embodiment of the present invention, the user of the mobile device 102 may control the recording. The user of the mobile device 102 may stop the recording, pause the recording, continue a paused recording, or delete a recorded broadcast.

In one embodiment of the present invention, the DVR 106 sends a confirmation of the recording to the mobile device 102. The confirmation may contain details such as availability of the broadcast to the DVR 106, and the time at which the DVR 106 started recording the broadcast.

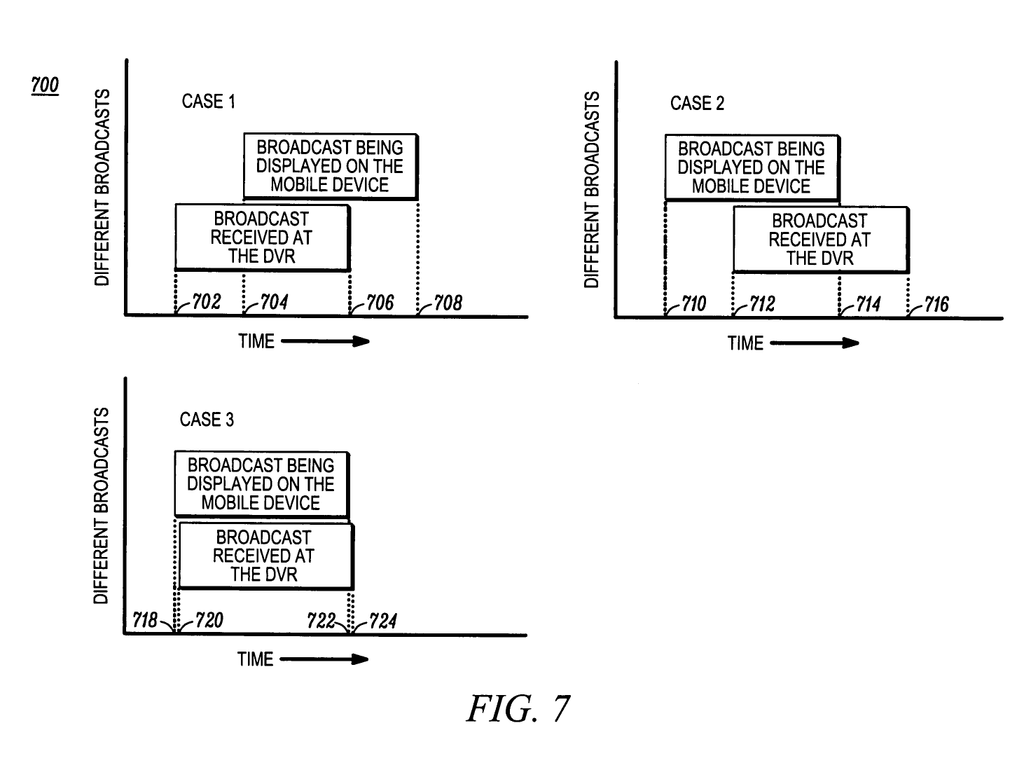

Referring to FIG. 7, there is shown a chart 700 depicting various cases for broadcast synchronization over the network 100, in accordance with an exemplary embodiment of the present invention. The broadcast from the first BS 202 and the broadcast from the second BS 204 may be transmitted at the same time or different time. Hence, broadcast synchronization is required for recording the broadcast. There may be three cases, as described in case 1, case 2, and case 3. Case 1 shows the broadcast received by the DVR 106 starts at time 702 and ends at time 706. Further, the broadcast displayed on the mobile device 102 starts at time 704 and ends at time 708. However, the time 702 is earlier than the time 704, i.e., the broadcast received at the DVR 106 starts before the broadcast being displayed on the mobile device 102 starts. In case 1, the server 104 notifies the mobile device 102 that the broadcast received at the DVR 106 has already started. The server 104 also notifies the mobile device 102 about the time difference between the broadcast received at the DVR 106 and the broadcast being displayed on the mobile device 102. The server 104 asks the user of the mobile device 102 whether the user wants to record the broadcast or discontinue the recording.

Case 2 shows that the broadcast being displayed on the mobile device 102 starts at time 710 and ends at time 714. Further, the broadcast received by the DVR 106 starts at time 712 and ends at time 716. The time 710 is earlier than the time 712, i.e. the broadcast being displayed on the mobile device 102 starts before the broadcast being received at the DVR 106 starts. In case 2, the sever 104 notifies the user of the mobile device 102 that the broadcast received at the DVR 106 has not yet started. Further, the server 104 notifies the user about the time 712 the broadcast will be available for recording at the DVR 106. The server 104 also asks the user of the mobile device 102 whether the user wants to record the broadcast or discontinue the recording.

Case 3 shows that the broadcast displayed on the mobile device 102 starts at time 718 and ends at time 722. Further, the broadcast received by the DVR 106 starts at time 720 and ends at time 724. However, the time 718 is almost equal to the time 720, i.e., the time difference between the broadcast displayed on the mobile device 102 and the broadcast received at the DVR 106 is less than or equal to a predefined value. The user of the mobile device 102 may set the predefined value. In case 3, the DVR 106 starts recording the broadcast received by the mobile device 102.

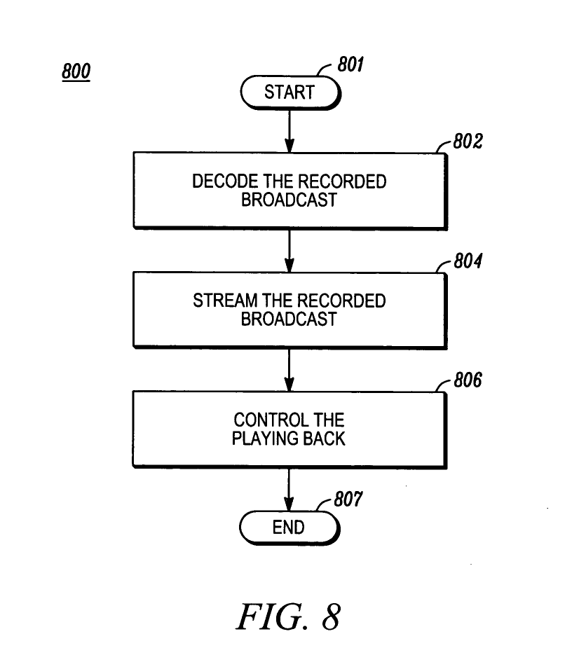

Referring to FIG. 8, there is shown a flow diagram 800 for playing back a recorded broadcast, in accordance with an exemplary embodiment of the present invention. After initiating the process at 801, the format decoder 310 decodes the recorded broadcast, at step 802. The format decoder 310 decodes the recorded broadcast in a predefined format. The predefined format may be selected on the basis of whether the recorded broadcast has to be displayed on the mobile device 102 or the display device 214. At step 804, the recorded broadcast is streamed to the mobile device 102 or the display device 214 in the predefined format. At step 806, the user controls the play back of the recorded broadcast. The user of the mobile device 102 may stop the play back, pause the play back, continue the play back, forward the play back, rewind the play back, and delete the recorded broadcast. Thereafter, the process terminates at step 807.

The user may cause the streaming of the recorded broadcast to pause for a desired length of time or may continue the play back after the streaming of the recorded broadcast has been paused. The user may also replay a portion of the recorded broadcast or may skip a portion of the play back. The user may also delete the recorded broadcast from the storage device 308 in the DVR 106.

In various embodiments of the present invention, the broadcast may be a video broadcast, an audio broadcast, an image broadcast, a data broadcast, or a combination of the above broadcasts.

Various embodiments of the present invention provide a system and a method for recording a broadcast. The broadcast may be spontaneously recorded on the DVR 106, since the user of the mobile device 102 is watching the broadcast on the mobile device 102.

Various embodiments of the present invention provide a method and a system for playing back a recorded broadcast. Playing back the recorded broadcast gives the user of the mobile device 102 the flexibility to watch the broadcast (that is recorded on the DVR 106) at a convenient time and place.

In an embodiment of the present invention, the EBG database 208 is accessed through the server 104. The implementation of the server 104 improves the efficiency of the system, as the access to the EBG database 208 through the server 104 is faster than the access to the EBG database 208 through the DVR 106.

Various embodiments of the present invention provide a system and a method to send the recorded broadcast to other electronic devices. The other electronic devices may be devices that are capable of storing the recorded broadcast or the display device 214. Accordingly, the recorded broadcast received by the electronic devices may either be stored on the electronic devices or may be displayed on the display device 214.

Various embodiments of the present invention provide a system and a method to that encode the broadcast in a desired format, such as a DVB-H, a DVB-S, a DVB-T, a MHEG, and a MPEG.

Various embodiments of the present invention provide a system and a method to control the recording of the broadcast by the mobile device 102. The user of the mobile device 102 may stop the recording, pause the recording, continue a paused recording, or delete a recorded broadcast.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A system for recording a broadcast, the broadcast being transmitted by a first Broadcast Source (BS) and a second Broadcast Source (BS), the system comprising:
a mobile device for displaying the broadcast being transmitted from the first BS, the mobile device generating a first information of the broadcast;
a server receiving the first information, a first identity of the first BS, and a second identity of the second BS; and
a Digital Video Recorder (DVR) capable of recording the broadcast being transmitted from the second BS based on a second information received from the server, the second information being generated based on the first information, the first identity, and the second identity.

2. The system of claim 1, further comprising an Electronic Broadcast Guide (EBG) database for storing details regarding the broadcast.

3. The system of claim 2, wherein the EBG database comprises an EBG interface for interacting with at least one of: the server, and a content source, wherein the content source transmits the broadcast to the first BS and the second BS.

4. The system of claim 1, wherein the DVR comprises a proactive shadow recorder for buffering the broadcast being transmitted from the second BS.

5. The system of claim 1, wherein the DVR comprises a format encoder for encoding the broadcast being transmitted from the second BS in a predefined format.

6. The system of claim 5, wherein the predefined format is selected from a group consisting of a Digital Video Broadcasting (DVB) DVB-S, a DVB-H, a DVB-T, a Multimedia and Hypermedia Expert Group (MHEG), a Moving Picture Experts Group (MPEG).

7. The system of claim 1, further comprising a tuner for providing the broadcast being transmitted from the second BS to the DVR.

8. The system of claim 1, wherein the first BS transmits the broadcast in a first format compatible to the mobile device and the second BS transmits the broadcast in a second format compatible to the DVR.

9. The system of claim 1, further comprising a display device connected to the DVR, the display device capable of displaying the broadcast.

10. The system of claim 1, wherein the broadcast is selected from a group consisting of a video broadcast, an audio broadcast, an image broadcast, a data broadcast, and a combination thereof.

11. A method for recording a broadcast, the broadcast being transmitted from a first Broadcast Source (BS) and a second BS, the broadcast being transmitted from the first BS being displayed on a mobile device, the method comprising:
selecting a recording option on the mobile device;
sending a first information of the broadcast being transmitted from the first BS, the first information being sent from the mobile device;
receiving the first information, a first identity of the first BS and a second identity of the second BS;
sending a second information to a Digital Video Recorder (DVR), the second information being generated based on the first information, the first identity, and the second identity; and
recording the broadcast being transmitted from the second BS based on the second information.

12. The method of claim 1 wherein sending the second information comprises sending a record instruction from the mobile device to the DVR.

13. The method of claim 11, further comprising querying an EBG database for details regarding the broadcast.

14. The method of claim 11, wherein recording the broadcast further comprises tuning the DVR to the broadcast being transmitted from the second BS based on the second information.

15. The method of claim 11, further comprising sending a confirmation from the DVR to the mobile device.

16. The method of claim 11, further comprising controlling the recording from the mobile device.

17. The method of claim 16, wherein controlling the recording comprises performing at least one of: stopping the recording, pausing the recording, and deleting the recording.

18. The method of claim 11, further comprising buffering the broadcast being transmitted from the second BS.

19. A method for playing back a recorded broadcast on a mobile device, the method comprising:
decoding the recorded broadcast in a predefined format;
streaming the recorded broadcast to the mobile device; and
controlling the playing back.

20. The method of claim 19, wherein controlling the playing back comprises performing at least one of: pausing the recorded broadcast, stopping the recorded broadcast, rewinding the recorded broadcast, forwarding the recorded broadcast, and deleting the recorded broadcast.
